(19) United States
(12) Patent Application Publication
(10) Pub. No.: US 2026/0094897 A1
(43) Pub. Date: Apr. 2, 2026

(54) ELECTRICITY STORAGE DEVICE AND VEHICLE

(71) Applicant: TOYOTA JIDOSHA KABUSHIKI KAISHA, Toyota-shi (JP)

(72) Inventor: Takuya MORIOKI, Nagoya-shi (JP)

(73) Assignee: TOYOTA JIDOSHA KABUSHIKI KAISHA, Toyota-shi (JP)

(21) Appl. No.: 19/218,949

(22) Filed: May 27, 2025

(30) Foreign Application Priority Data
Oct. 2, 2024 (JP) 2024-173166

(51) Int. Cl. H01M 10/6568; H01M 10/613

(52) U.S. Cl. CPC H01M 10/6568; H01M 10/613; H01M 2220/20

(57) ABSTRACT

An electricity storage device includes: an electricity storage module; a cooler that cools the electricity storage module; a refrigerant pipe which is installed on an outer side of the cooler and through which a refrigerant flows; a fixing member to which the electricity storage module is fixed and in which a refrigerant flow passage is provided; a device base disposed above the electricity storage module; a bracket that fixes the device base to the fixing member; and an electric device disposed on the device base. The fixing member includes a first fitting part fitted on the refrigerant pipe and a second fitting part fitted on the cooler. In a state where the first fitting part is fitted on the refrigerant pipe and the second fitting part is fitted on the cooler, the refrigerant flow passage is connected to the refrigerant pipe and a flow passage inside the cooler.

### CROSS-REFERENCE TO RELATED APPLICATION

This application claims priority to Japanese Patent Application No. 2024-173166 filed on Oct. 2, 2024. The disclosure of the above-identified application, including the specification, drawings, and claims, is incorporated by reference herein in its entirety.

### BACKGROUND

### 1. Technical Field

This disclosure relates to an electricity storage device and a vehicle including this electricity storage device.

### 2. Description of Related Art

As a conventional electricity storage device, Japanese Unexamined Patent Application Publication No. 2021-034251 (JP 2021-034251 A) discloses a structure provided with a device cooling part that cools an electric device disposed inside a housing case. The device cooling part is disposed facing the electric device, and a refrigerant that cools the electric device flows through this device cooling part.

### SUMMARY

An electric device is sometimes disposed, for example, above an electricity storage module in consideration of installation space. When a device cooling part through which a refrigerant flows is disposed above the electricity storage module to cool the electric device, it is feared that dew condensation may occur around the device cooling part and that dew condensation water may attach to the electricity storage module located under the device cooling part by dripping onto it, for example. In such a case, it is feared that the electricity storage module may short-circuit due to the dew condensation water.

This disclosure has been made in view of the problem as described above, and an object of this disclosure is to provide an electricity storage device that can cool an electric device disposed above an electricity storage module while inhibiting dew condensation, and a vehicle.

An electricity storage device based on this disclosure includes: an electricity storage module; a cooler that cools the electricity storage module; a refrigerant pipe which is installed on an outer side of the cooler and through an inside of which a refrigerant flows; a fixing member to which the electricity storage module is fixed and in an inside of which a refrigerant flow passage is provided; a device base disposed above the electricity storage module; a bracket that fixes the device base to the fixing member; and an electric device disposed on the device base. The fixing member includes a first fitting part that is fitted on the refrigerant pipe and a second fitting part that is fitted on the cooler. In a state where the first fitting part is fitted on the refrigerant pipe and the second fitting part is fitted on the cooler, the refrigerant flow passage is connected to the refrigerant pipe and a flow passage inside the cooler. The device base is thermally in contact with the fixing member through the bracket.

With this configuration, a heat transfer path is formed between the electric device and the fixing member and further the cooler through the bracket and the device base. Thus, heat from the electric device can be cooled through the heat transfer path by the refrigerant flowing through the fixing member and the cooler. As a result, the electric device can be cooled. In addition, since the cooler is not directly in contact with the electric device, occurrence of dew condensation around the electric device can be inhibited.

In the above-described electricity storage device based on this disclosure, the bracket may have heat conductivity.

When the bracket constituting a part of the heat transfer path has heat conductivity as in this configuration, the electric device can be effectively cooled.

In the above-described electricity storage device based on this disclosure, the device base may have heat conductivity.

In this configuration, the device base constituting a part of the heat transfer path has heat conductivity, so that the electric device can be effectively cooled.

A vehicle based on this disclosure includes the above-described electricity storage device and a vehicle main body in which a rear seat is provided. The electric device is disposed under the rear seat.

In this configuration, the electric device located above the electricity storage module is disposed under the rear seat, and thus a space under the rear seat can be effectively used.

This disclosure can provide an electricity storage device that can cool an electric device disposed above an electricity storage module while inhibiting dew condensation, and a vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic view showing a vehicle according to an embodiment;

FIG. 2 is an exploded perspective view of an electricity storage device according to the embodiment;

FIG. 3 is a view of an inside of a main part of the electricity storage device according to the embodiment as seen from above;

FIG. 4 is a perspective view schematically showing fixing members and coolers in the electricity storage device according to the embodiment;

FIG. 5 is a view showing how a device base is fixed in the electricity storage device according to the embodiment; and

FIG. 6 is a sectional view along line VI-VI indicated in FIG. 5.

### DETAILED DESCRIPTION OF EMBODIMENTS

An embodiment of this disclosure will be described in detail below with reference to the drawings. In the embodiment to be shown below, the same or common parts are denoted by the same reference sign in the drawings and description thereof will not be repeated.

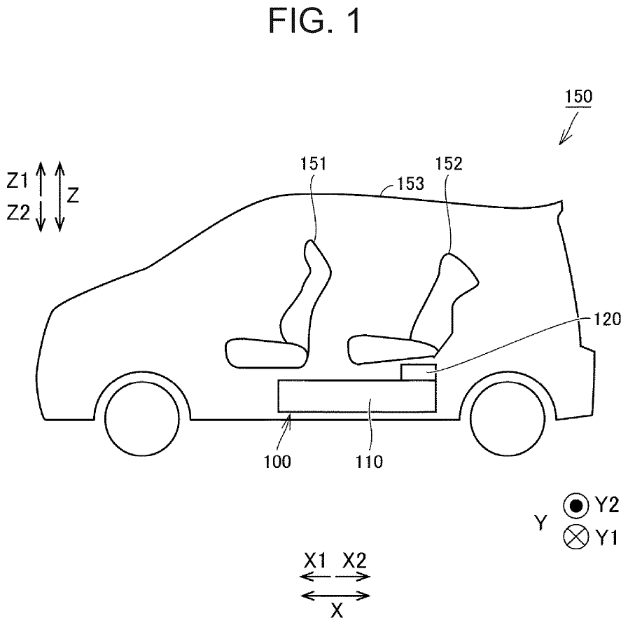

FIG. 1 is a schematic view of a vehicle including an electricity storage device according to the embodiment. A vehicle 150 according to the embodiment will be described with reference to FIG. 1.

The vehicle 150 is, for example, a hybrid electric vehicle, a plug-in hybrid electric vehicle, or a battery electric vehicle.

The vehicle 150 includes a vehicle main body 153 in which a front seat 151 and a rear seat 152 are provided, and an electricity storage device 100. The electricity storage device 100 is disposed at a lower part of or under the vehicle main body 153. The electricity storage device 100 includes a main part 110 and a device unit 120. The device unit 120 is located at an end portion of the electricity storage device 100 in an X-direction. The device unit 120 protrudes upward (toward a Z1-side) from the main part 110. The device unit 120 is disposed under (on a Z2-side of) a cushion seat of the rear seat 152. Thus, a space under the rear seat 152 can be effectively used.

In this disclosure, the X-direction, a Y-direction, and a Z-direction are orthogonal to one another. For example, the X-direction is a front-rear direction of the vehicle 150, and the Y-direction is a width direction of the vehicle 150. An X1-direction is a direction from a rear side of the vehicle 150 toward a front side of the vehicle 150. An X2-direction is a direction from the front side of the vehicle 150 toward the rear side of the vehicle 150. A Y1-direction is a direction from a right side of the vehicle 150 toward a left side of the vehicle 150. A Y2-direction is a direction from the left side of the vehicle 150 toward the right side of the vehicle 150. The Z-direction is an up-down (vertical) direction. A Z1-direction is a direction from a lower side of the vehicle 150 toward an upper side of the vehicle 150. A Z2-direction is a direction from the upper side of the vehicle 150 toward the lower side of the vehicle 150. In this disclosure, the Z1-direction will be referred to also as upward or the upper side, and the Z2-direction will be referred to also as downward or the lower side.

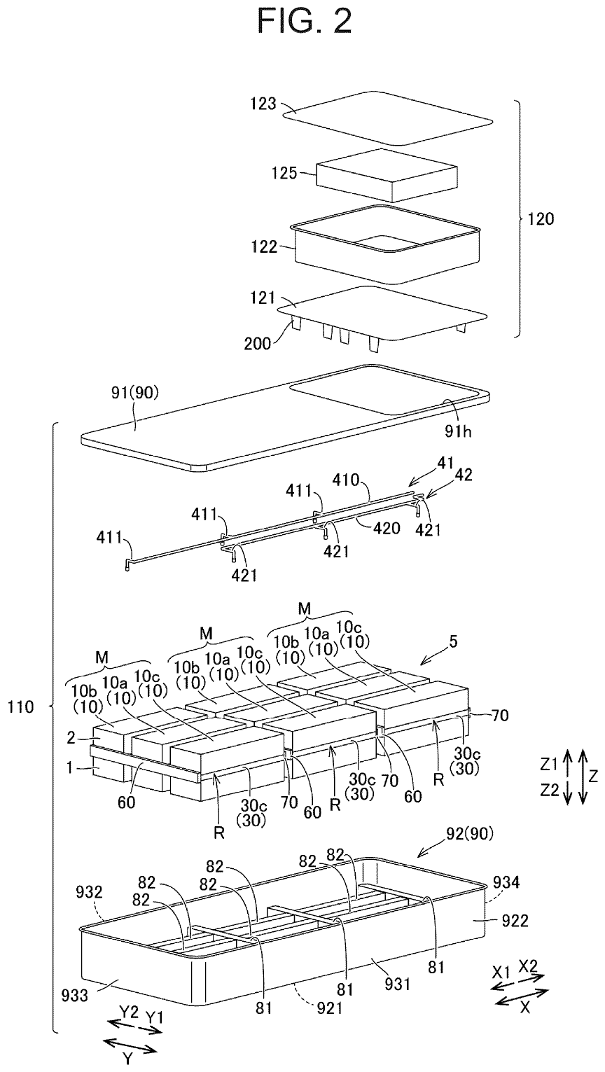

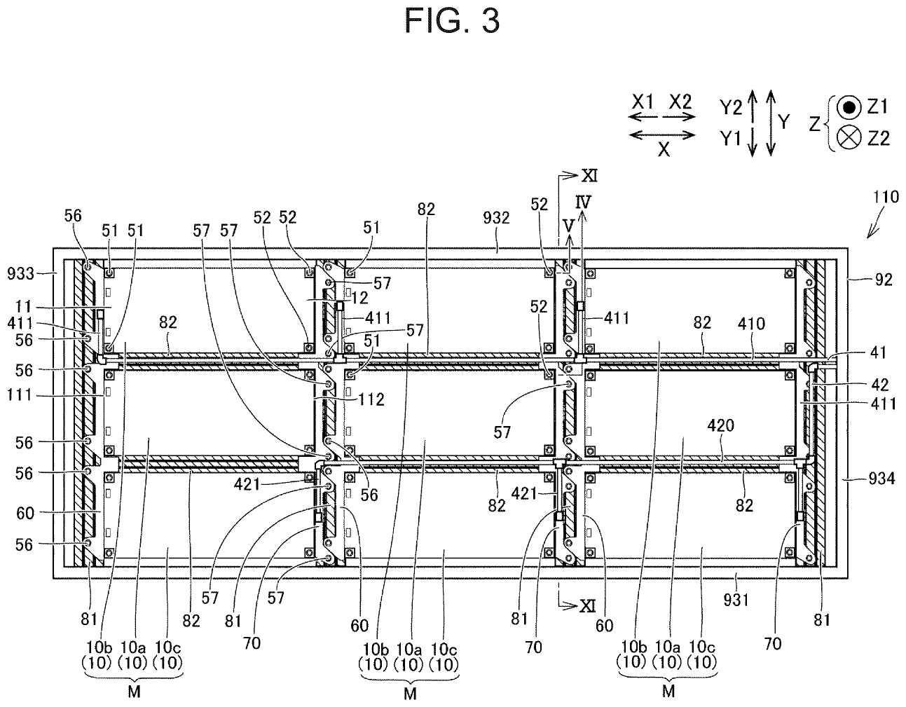

FIG. 2 is an exploded perspective view of the electricity storage device according to the embodiment. FIG. 3 is a view of an inside of the main part of the electricity storage device according to the embodiment as seen from above. In FIG. 3, an upper member 91, to be described later, is omitted for convenience. The electricity storage device 100 according to the embodiment will be described with reference to FIG. 2 and FIG. 3.

As shown in FIG. 2 and FIG. 3, the main part 110 includes a housing case 90, a plurality of reinforcing members 81, a plurality of reinforcing members 82, an electricity storage unit 5, a plurality of cooling units R, refrigerant pipes 41, 42, a plurality of fixing members 60 (first fixing members), and a plurality of fixing members 70 (second fixing members).

The housing case 90 houses the reinforcing members 81, the reinforcing members 82, the electricity storage unit 5, the cooling units R, the refrigerant pipes 41, 42, the fixing members 60, and the fixing members 70.

The housing case 90 includes the upper member 91 and a lower case 92. The lower case 92 has a substantially box-like shape that is open upward.

The lower case 92 includes a bottom wall 921 and a peripheral wall 922. The peripheral wall 922 rises from a peripheral edge portion of the bottom wall 921. The peripheral wall 922 includes side walls 931 to 934. The side wall 931 and the side wall 932 are disposed at an interval in the Y-direction. The Y-direction is orthogonal to the X-direction and parallel to the width direction of the vehicle. The Y-direction corresponds to a first direction. The side wall 933 and the side wall 934 are disposed at an interval in the X-direction.

The upper member 91 partially closes the opening of the lower case 92. The upper member 91 may have a plate-like shape or may have a substantially box-like shape that is open downward. At an end portion of the upper member 91 in the X2-direction, an open part 91h is provided. The open part 91h is provided such that, when seen from above, a module row M, to be described later, that is located farthest in the X2-direction and the two reinforcing members 81 located on outer sides of that module row M in the X-direction are exposed. The open part 91h is closed by a device base 121 to be described later.

The reinforcing members 81 include four reinforcing members 81. The four reinforcing members 81 are arranged at intervals in the X-direction. Each of the four reinforcing members 81 extends in the Y-direction. The number of the reinforcing members 81 is not limited to four. At a minimum, the lower case 92 should be provided with one or more reinforcing members 81.

The reinforcing members 82 include six reinforcing members 82. More specifically, two reinforcing members 82 are arranged at an interval in the Y-direction between each pair of reinforcing members 81 lying next to each other in the X-direction. Each of the six reinforcing members 82 extends in the X-direction. The number of the reinforcing members 82 is not limited to six. At a minimum, the lower case 92 should be provided with one or more reinforcing members 82.

A housing space inside the housing case 90 is divided by the reinforcing members 81, 82 into a plurality of (in this embodiment, nine) spaces. In each of the nine spaces, one electricity storage module 10 is disposed.

The electricity storage unit 5 includes a plurality of electricity storage modules 10. The electricity storage modules 10 include nine electricity storage modules 10. The nine electricity storage modules 10 are connected in series by a busbar (not shown). The number of the electricity storage modules 10 is not limited to nine.

The nine electricity storage modules 10 are disposed in a three-by-three matrix form in an XY-plane. Specifically, three module rows M, each made up of three electricity storage modules 10 lying next to one another in the Y-direction, are arranged in the X-direction.

Each module row M includes a first electricity storage module 10a, a second electricity storage module 10b, and a third electricity storage module 10c. The first electricity storage module 10a is an electricity storage module 10 that is disposed at a center of the three electricity storage modules 10 in the module row M. The second electricity storage module 10b is an electricity storage module 10 that is disposed farthest on a Y2-side of the three electricity storage modules 10 in the module row M. The third electricity storage module 10c is an electricity storage module 10 that is disposed farthest on a Y1-side of the three electricity storage modules 10 in the module row M. The second electricity storage module 10b and the first electricity storage module 10a are adjacent to each other in a horizontal direction, and the first electricity storage module 10a and the third electricity storage module 10c are adjacent to each other in the horizontal direction.

Each electricity storage module 10 includes a side surface 111 and a side surface 112 that are disposed at an interval in the X-direction. The side surface 111 is disposed farther on an X1-side than the side surface 112.

Each electricity storage module 10 includes a lower module 1 and an upper module 2. The upper module 2 is disposed above (farther on the Z1-side than) the lower module 1. The lower module 1 and the upper module 2 are stacked in the Z-direction with a cooler 30 therebetween. Each electricity storage module 10 may include only either the lower module 1 or the upper module 2.

The cooling units R are provided such that a refrigerant can flow therethrough. The cooling units R cool the electricity storage unit 5. One cooling unit R is provided for each module row M. In this embodiment, the cooling units R include three cooling units R.

Each cooling unit R is disposed between the lower modules 1 and the upper modules 2. Each cooling unit R includes three coolers 30, and each cooler 30 is disposed between the lower module 1 and the upper module 2.

The refrigerant pipe 41 is a pipe through which the refrigerant passes. The refrigerant pipe 41 is a pipe through which the refrigerant to be supplied to each cooling unit R passes. The refrigerant pipe 41 includes a main pipe 410 and three sub-pipes 411 branching off from the main pipe 410.

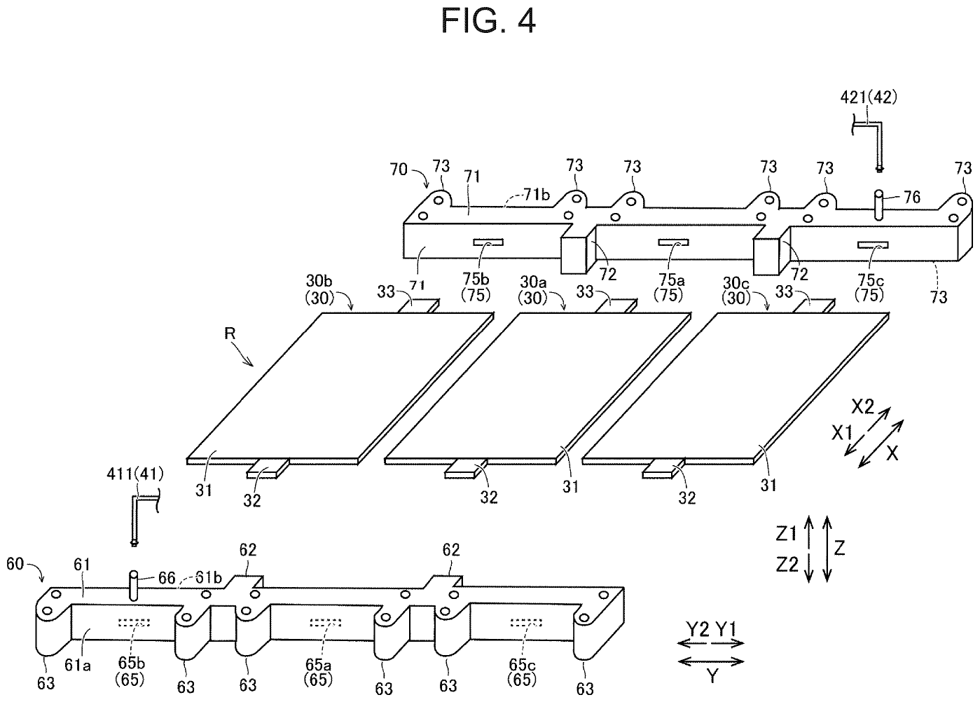

The main pipe 410 extends in the X-direction between the second electricity storage modules 10b and the first electricity storage modules 10a. The three sub-pipes 411 each extend, for example, along the side surface 111 of the corresponding one of the three second electricity storage modules 10b lying next to one another in the X-direction. Each sub-pipe 411 is connected to a first fitting part 66 (see FIG. 4) that is formed on the fixing member 60 provided on the side of the side surface 111. A refrigerant flow passage is formed inside the fixing member 60, and this refrigerant flow passage and the refrigerant pipe 41 are connected to each other through the first fitting part 66. The refrigerant pipe 41 has, for example, a cylindrical shape.

The refrigerant pipe 42 is a pipe through which the refrigerant passes. The refrigerant pipe 42 is a pipe through which the refrigerant discharged from each cooling unit R passes. The refrigerant pipe 42 includes a main pipe 420 and three sub-pipes 421 branching off from the main pipe 420.

The main pipe 420 extends in the X-direction between the first electricity storage modules 10a and the third electricity storage modules 10c. The three sub-pipes 421 each extend along the side surface 112 of the corresponding one of the three third electricity storage modules 10c lying next to one another in the X-direction. Each sub-pipe 421 is connected to a third fitting part 76 (see FIG. 4) that is formed on the fixing member 70 provided on the side surface 112. A refrigerant flow passage is formed inside the fixing member 70, and this refrigerant flow passage and the refrigerant pipe 42 are connected to each other through the third fitting part 76. The refrigerant pipe 42 has, for example, a cylindrical shape.

Each of the fixing members 60, 70 is fixed on the lower case 92 through the reinforcing member 81. Each of the fixing members 60, 70 fixes the electricity storage unit 5 to the lower case 92. More specifically, each of the fixing members 60, 70 fixes the module row M made up of the three electricity storage modules 10 (the first electricity storage module 10a, the second electricity storage module 10b, and the third electricity storage module 10c) to the lower case 92. Each of the fixing members 60, 70 may be formed from, for example, aluminum.

Each of the fixing members 60, 70 is provided for each module row M. Specifically, the fixing members 60 include three fixing members 60, and the fixing members 70 include three fixing members 70. The numbers of the fixing members 60 and the fixing members 70 are not limited to three. The numbers of the fixing members 60 and the fixing members 70 can vary according to the number of the module rows M.

Each of the fixing members 60, 70 couples (connects) the three electricity storage modules 10 (the first electricity storage module 10a, the second electricity storage module 10b, and the third electricity storage module 10c) of the module row M to one another. Each of the fixing members 60, 70 extends in the Y-direction so as to straddle the first electricity storage module 10a, the second electricity storage module 10b, and the third electricity storage module 10c. More specifically, the fixing member 60 is provided so as to straddle the side surfaces 111 of the three electricity storage modules 10 (the first electricity storage module 10a, the second electricity storage module 10b, and the third electricity storage module 10c) lying next to one another in the Y-direction. The fixing member 70 is provided so as to straddle the side surfaces 112 of the three electricity storage modules 10 (the first electricity storage module 10a, the second electricity storage module 10b, and the third electricity storage module 10c) lying next to one another in the Y-direction.

Each of the fixing members 60, 70 couples the lower module 1 and the upper module 2 of each of the three electricity storage modules 10 of the module row M to each other.

The electricity storage device 100 further includes bolts 56 and bolts 57. The bolts 56 fasten the fixing members 60 and the reinforcing members 81 together. The bolts 57 fasten the fixing members 70 and the reinforcing members 81 together.

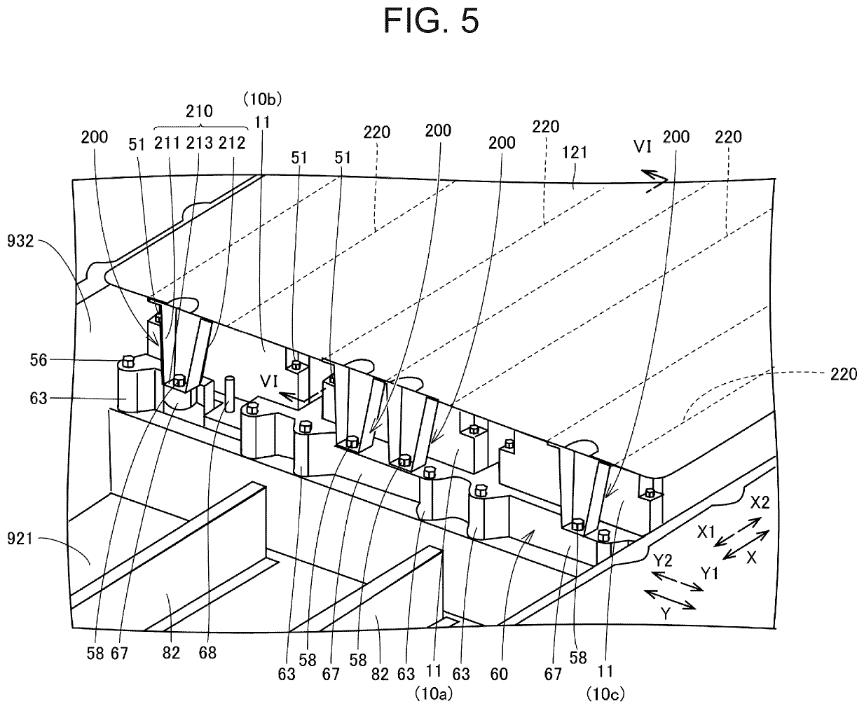

Each electricity storage module 10 includes a coupling portion 11 and a coupling portion 12 that are disposed at an interval in the X-direction. The coupling portion 11 is disposed farther on the X1-side than the coupling portion 12. The electricity storage module 10 is fixed to the fixing members 60, 70 by bolts 51 (see FIG. 5). Specifically, the coupling portion 11 is fixed to the fixing members 60 by the bolts 51. The coupling portion 12 is fixed to the fixing members 70 by the bolts. Both end portions of each of the coupling portions 11, 12 in the Y-direction are fixed to a bracket by the bolts.

The coupling portions 11, 12 may be formed by, for example, end plates. In this case, each electricity storage module 10 includes a plurality of electricity storage cells arranged in the X-direction, and end plates that are disposed at both ends in the X-direction and sandwich the electricity storage cells. The electricity storage cells may be secondary batteries, such as nickel-metal hydride batteries or lithium-ion batteries. The electricity storage cells may use a liquid electrolyte or may use a solid electrolyte. Or the electricity storage cells may be chargeable and dischargeable capacitors.

The device unit 120 includes the device base 121, a housing frame 122, a lid body 123, an electric device 125, and a plurality of brackets 200.

The device base 121 is disposed above the three electricity storage modules 10 of the module row M that is located farthest on an X2-direction side. The device base 121 has a plate-like shape. The device base 121 closes the open part 91h of the upper member 91. The electric device 125 is disposed on the device base 121. The device base 121 has a lower surface that faces the three electricity storage modules 10 located farthest on the X2-direction side and an upper surface that faces upward. The electric device 125 is disposed on the upper surface of the device base 121.

The housing frame 122 surrounds the electric device 125. The housing frame 122 may be made of a metal material, such as SUS. The housing frame 122 has a tubular shape that is open outward at an upper part and a lower part. The opening of the housing frame 122 on the lower side is closed by the device base 121. The opening of the housing frame 122 on the upper side is closed by the lid body 123. The lid body 123 has a substantially plate-like shape.

The electric device 125 includes, for example, an electronic control unit and a junction box. The electronic control unit and the junction box may be disposed side by side on the device base 121, or may be disposed on the device base 121 in a state of being stacked in the up-down direction.

FIG. 4 is a perspective view schematically showing the fixing members and the coolers in the electricity storage device according to the embodiment.

As shown in FIG. 4, the cooling unit R includes three coolers 30. More specifically, each cooling unit R includes a first cooler 30a, a second cooler 30b, and a third cooler 30c. The first cooler 30a cools the first electricity storage module 10a. The second cooler 30b cools the second electricity storage module 10b. The third cooler 30c cools the third electricity storage module 10c. Thus, in this embodiment, the case where nine coolers 30 are provided is illustrated, but the number of the coolers 30 is not limited to nine. The number of the coolers 30 can vary according to the number of the electricity storage modules 10.

The cooler 30 is disposed between the lower module 1 and the upper module 2. A heat conducting member may be provided between the cooler 30 and each module. The heat conducting member has, for example, higher heat conductivity than air (air gap). As the heat conducting member, for example, an adhesive containing silicon-based resin, acrylic resin, epoxy resin, or the like can be adopted. When a heat conducting member is thus provided, heat conductivity between the cooler 30 and each of the lower module 1 and the upper module 2 can be improved.

The cooler 30 has, for example, a plate-like outer shape. The cooler 30 includes a main body portion 31, an insertion portion 32, and an insertion portion 33. The insertion portion 32 protrudes from the main body portion 31 toward the X1-side. The insertion portion 33 protrudes from the main body portion 31 toward the X2-side.

The fixing member 60 has a main body portion 61, a plurality of first protruding portions 62, and a plurality of second protruding portions 63. The main body portion 61 extends along the Y-direction on outer sides of the first electricity storage module 10a, the second electricity storage module 10b, and the third electricity storage module 10c. The main body portion 61 has side surfaces 61a, 61b that are disposed at an interval in the X-direction. The side surface 61b is located farther on the X2-side than the side surface 61a.

In the side surface 61b, a plurality of unit insertion ports 65 is provided. In the unit insertion ports 65, the cooling unit R is inserted. Specifically, the unit insertion ports 65 have insertion ports 65a, 65b, 65c. In the insertion port 65a, the insertion portion 32 of the first cooler 30a is inserted. In the insertion port 65b, the insertion portion 32 of the second cooler 30b is inserted. In the insertion port 65c, the insertion portion 32 of the third cooler 30c is inserted.

The first protruding portions 62 protrude from the main body portion 61 in an intersection direction that intersects the Y-direction. Specifically, the first protruding portions 62 protrude from the main body portion 61 in the X2-direction. The first protruding portions 62 enter gaps between the electricity storage modules lying adjacent to one another in the corresponding module row M. The first protruding portions 62 include a protruding portion that enters a gap between the first electricity storage module 10a and the second electricity storage module 10b, and a protruding portion that enters a gap between the first electricity storage module 10a and the third electricity storage module 10c. The bolts 51 that penetrate the coupling portions 11 are inserted through the first protruding portions 62 to thereby fix the electricity storage modules 10 to the fixing member 60.

The second protruding portions 63 protrude from the main body portion 61 toward the opposite side from the side toward which the first protruding portions 62 protrude from the main body portion 61. The second protruding portions 63 are disposed at positions corresponding to both end portions of the respective electricity storage modules 10 in the Y-direction. A through-hole is provided in each second protruding portion 63, and the bolts 56 are inserted through these through-holes to thereby fix the fixing member 60 to the reinforcing member 81.

The fixing member 70 has a main body portion 71, a plurality of first protruding portions 72, and a plurality of second protruding portions 73. The main body portion 71 extends along the Y-direction on outer sides of the first electricity storage module 10a, the second electricity storage module 10b, and the third electricity storage module 10c. The main body portion 71 has side surfaces 71a, 71b that are disposed at an interval in the X-direction. The side surface 71b is located farther on the X2-side than the side surface 71a.

In the side surface 71a, a plurality of unit insertion ports 75 is provided. In the unit insertion ports 75, the cooling unit R is inserted. Specifically, the unit insertion ports 75 have insertion ports 75a, 75b, 75c. In the insertion port 75a, the insertion portion 33 of the first cooler 30a is inserted. In the insertion port 75b, the insertion portion 33 of the second cooler 30b is inserted. In the insertion port 75c, the insertion portion 33 of the third cooler 30c is inserted. As the insertion portions 32, 33 are thus inserted in the unit insertion ports 65, 75, the flow passages inside the coolers 30 and the refrigerant flow passages formed inside the fixing members 60, 70 are connected to each other.

The unit insertion port 65 corresponds to a second fitting part, and in a state where the insertion portion 32 of the cooler 30 is fitted in the second fitting part, the flow passage inside the cooler 30 and the refrigerant flow passage formed inside the fixing member 60 are connected to each other.

As the insertion portions 32, 33 are inserted in the unit insertion ports 65, 75, the coolers 30 are retained by the fixing members 60, 70. The insertion portions 32, 33 are liquid-tightly fixed in the unit insertion ports 65, 75.

The first protruding portions 72 protrude from the main body portion 71 in an intersection direction that intersects the Y-direction. Specifically, the first protruding portions 72 protrude from the main body portion 71 in the X1-direction. The first protruding portions 72 enter gaps between the electricity storage modules lying adjacent to one another in the corresponding module row M. The first protruding portions 72 include a protruding portion that enters a gap between the first electricity storage module 10a and the second electricity storage module 10b, and a protruding portion that enters a gap between the first electricity storage module 10a and the third electricity storage module 10c. Bolts 52 that penetrate the coupling portions 12 are inserted through the first protruding portions 72 to thereby fix the electricity storage modules 10 to the fixing member 70.

The second protruding portions 73 protrude from the main body portion 71 toward the opposite side from the side toward which the first protruding portions 72 protrude from the main body portion 71. The second protruding portions 73 are disposed at positions corresponding to both end portions of the respective electricity storage modules 10 in the Y-direction. A through-hole is provided in each second protruding portion 73, and the bolts 57 are inserted through these through-holes to thereby fix the fixing member 70 to the reinforcing member 81.

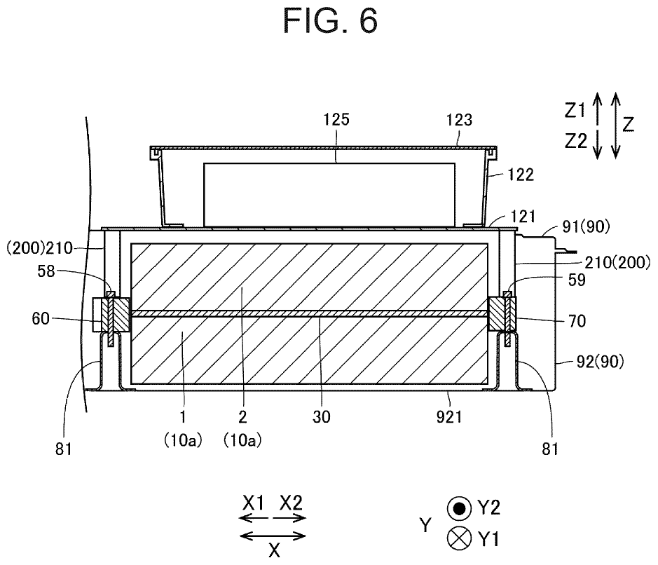

FIG. 5 is a view showing how the device base is fixed in the electricity storage device according to the embodiment. FIG. 6 is a sectional view along line VI-VI indicated in FIG. 5.

As shown in FIG. 5 and FIG. 6, the device base 121 is fixed to the fixing member 60 and the fixing member 70 by the brackets 200. The fixing members 60, 70 are made of a metal material, such as aluminum, as described above, and therefore the device base 121 is thermally in contact with the fixing members 60, 70 through the brackets 200. The brackets 200 are made of, for example, a metal material, such as aluminum. When the brackets 200 are made of aluminum, the bracket 200 has high heat conductivity.

An end portion of the device base 121 located in the X1-direction is fixed to the fixing member 60 by, for example, four brackets 200, and an end portion of the device base 121 located in the X2-direction is fixed to the fixing member 70 by, for example, four brackets 200.

The four brackets 200 fixed to the fixing member 60 include two brackets 200 that are located on the X1-direction side (front side) of the first electricity storage module 10a, a bracket 200 that is located on the X1-direction side of the second electricity storage module 10b, and a bracket 200 that is located on the X1-direction side of the third electricity storage module 10c. When two brackets 200 are thus disposed on the X1-direction side of the first electricity storage module 10a located at the center of the module row M in the Y-direction, the device base 121 can be stably supported.

The four brackets 200 fixed to the fixing member 70 are disposed in almost the same manner as the four brackets 200 fixed to the fixing member 60. Thus, the device base 121 can be stably supported.

The number of the brackets 200 that fix the device base 121 to the fixing members 60, 70 is not limited to four and can be set as appropriate.

Each bracket 200 has support parts 210 and a plate-like part 220. The support parts 210 are fixed to the fixing members 60, 70 and support the device base 121. Each support part 210 has a substantially U-shape. Specifically, each support part 210 has a pair of vertical wall portions 211, 212 and a bottom wall portion 213.

The vertical wall portions 211, 212 are disposed next to each other in the Y-direction. A surface with a largest area of each of the vertical wall portions 211, 212 faces the Y-direction. The vertical wall portions 211, 212 extend in the up-down direction. The vertical wall portions 211, 212 may be inclined so as to approach each other as they extend downward. Upper ends of the vertical wall portions 211, 212 are connected to the device base 121.

The bottom wall portion 213 connects lower ends of the vertical wall portions 211, 212 to each other. The bottom wall portions 213 are fixed to the fixing members 60, 70 by bolts 58, 59. Specifically, the bottom wall portion 213 of the bracket 200 located on the X1-direction side is fixed to a mounting portion 67 of the fixing member 60 by the bolt 58. The bottom wall portion 213 of the bracket 200 located on the X2-direction side is fixed to a mounting portion of the fixing member 70 by the bolt 59. The bolts 58, 59 are inserted through the reinforcing members 81 as well, and thus the bracket 200 can be more firmly fixed.

The plate-like part 220 extends along the X-direction. In each of the brackets 200 lying next to one another in the X-direction, the plate-like part 220 connects upper ends of the support parts 210 to each other. The plate-like part 220 is in contact with a lower surface of the device base 121. Each plate-like part 220 is provided so as to straddle upper ends of the vertical wall portions 211, 212. Thus providing the plate-like part 220 can increase an area of contact between the device base 121 and the bracket 200 to thereby effectively transfer heat from the device base 121 to the bracket 200.

As the device base 121 is thus fixed (connected) by the brackets 200 to the fixing members 60, 70 to which the coolers 30 are connected, heat released from the electric device 125 passes through a heat transfer path that is formed between the electric device 125 and the fixing members 60, 70 and further between the electric device 125 and the coolers 30 through the device base 121 and the brackets 200.

As described above, the refrigerant flow passages are formed inside the fixing members 60, 70. In a state where the first fitting part 66 is fitted in the refrigerant pipe 41 (more particularly, a joint part of the sub-pipe 421) and the unit insertion ports 65 as the second fitting parts and the insertion portions 32 of the coolers 30 are fitted on each other, the refrigerant flow passages are connected to the refrigerant pipe and the flow passages inside the coolers 30.

Thus, heat from the electric device 125 can be cooled through the heat transfer path by the refrigerant flowing through the fixing members 60, 70 and the coolers 30. As a result, the electric device 125 can be cooled. In addition, since the coolers 30 are not directly in contact with the electric device 125, occurrence of dew condensation around the electric device 125 can be inhibited.

Moreover, since the brackets 200 constituting a part of the heat transfer path have heat conductivity, the electric device 125 can be effectively cooled. In addition, since the device base 121 constituting a part of the heat transfer path has heat conductivity, the electric device 125 can be effectively cooled.

While the above description has been given by illustrating the case where the bracket 200 includes the plate-like part 220, this disclosure is not limited thereto and the plate-like part 220 may be omitted.

The embodiment disclosed this time is in every respect illustrative and not restrictive. The scope of the present disclosure is indicated by the claims and includes all changes within the meaning and scope of equivalents of the claims.

What is claimed is:

1. An electricity storage device comprising:
an electricity storage module;
a cooler that cools the electricity storage module;
a refrigerant pipe which is installed on an outer side of the cooler and through an inside of which a refrigerant flows;
a fixing member to which the electricity storage module is fixed and in an inside of which a refrigerant flow passage is provided;
a device base disposed above the electricity storage module;
a bracket that fixes the device base to the fixing member; and
an electric device disposed on the device base, wherein:
the fixing member includes a first fitting part that is fitted on the refrigerant pipe and a second fitting part that is fitted on the cooler;
in a state where the first fitting part is fitted on the refrigerant pipe and the second fitting part is fitted on the cooler, the refrigerant flow passage is connected to the refrigerant pipe and a flow passage inside the cooler; and
the device base is thermally in contact with the fixing member through the bracket.

2. The electricity storage device according to claim 1, wherein the bracket has heat conductivity.

3. The electricity storage device according to claim 1, wherein the device base has heat conductivity.

4. A vehicle comprising:
the electricity storage device according to claim 1; and
a vehicle main body in which a rear seat is provided, wherein the electric device is disposed under the rear seat.
